(19) United States
(12) Patent Application Publication
(10) Pub. No.: US 2016/0029616 A1
(43) Pub. Date: Feb. 4, 2016

(54) PEST DETERRENT BARRIER

(71) Applicant: Brandon Johnston, Gilmer, TX (US)

(72) Inventor: Brandon Johnston, Gilmer, TX (US)

(21) Appl. No.: 14/810,956

(22) Filed: Jul. 28, 2015

Related U.S. Application Data
(60) Provisional application No. 61/999,603, filed on Aug. 1, 2014.

(51) Int. Cl. A01M 29/34; E04B 1/72; A01M 1/20

(52) U.S. Cl. CPC A01M 29/34; A01M 1/20; E04B 1/72

(57) ABSTRACT

Pest-deterring barriers are described herein. The barriers are configured to attach to a structure in such a way so as to provide a physical barrier that prevents pests from entering an enclosure. The pest-deterring barriers are made of a material that deters pests from approaching, touching, or traversing the barrier. The pest-deterring barriers have an attachment portion for attaching to a structure and an active barrier portion made of the pest-deterring material. The barrier portion can be easily removed and exchanged periodically. Replacement barrier portions are described herein, as are methods of deterring pests using the described pest-deterring barriers.

### FIELD OF THE INVENTION

This application relates to the field of pest control, and more particular, to hardware for living and storage spaces that is treated to repel pests.

### BACKGROUND

Keeping pests from entering enclosures such as living and storage spaces be can a constant battle. Pests are tenacious in their efforts to enter spaces and will try to gain access through any openings—spaces beneath doors, between windows and window sills, through duct work and receptacles for electrical outlets, light switches, etc. Once pests have gained entry into a space, getting rid of them can be very difficult and may require toxic and/or messy treatments. Thus, there is a need for effective, convenient, and eco-friendly methods of keeping pests from entering enclosures.

### SUMMARY

Numerous embodiments of pest-deterring barriers are described herein. The barriers are configured to attach to a structure in such a way so as to provide a physical barrier that prevents pests from entering an enclosure. The pest-deterring barriers are made of a material that deters pests from approaching, touching, or traversing the barrier. According to certain embodiments, the pest-deterring barriers are configured with an attachment portion for attaching to a structure and an active barrier portion made of the pest-deterring material. The attachment portion may attach to a structure in a permanent or semi-permanent manner and the barrier portion may attach to the attachment portion in a manner that allows the barrier portion to be easily removed and exchanged periodically. Replacement barrier portions are described herein, as are methods of deterring pests using the described pest-deterring barriers.

### BRIEF DESCRIPTION OF THE DRAWINGS

FIG. 1 illustrates a door sweep having a pest-deterring barrier.

FIG. 2 illustrates a close-up view of a door sweep having a pest-deterring barrier.

FIG. 3 illustrates a close-up view of a door sweep having a pest-deterring barrier adhered to a connecting portion via an adhesive strip.

FIG. 4 illustrates a process for manufacturing a pest deterring barrier material.

FIGS. 5 and 6 illustrate an alternative embodiment of a pest-deterring barrier.

FIG. 7 illustrates a pest-deterring barrier for installation on a window.

FIG. 8 illustrates a close-up view of a pest-deterring barrier for installation on a window.

FIG. 9 illustrates a pest-deterring barrier for sealing a window air conditioner unit within a window.

FIG. 10 illustrates a pest-deterring barrier configured as a gasket for insertion into an electric receptacle.

### DESCRIPTION

Pest-deterrent barriers are described herein. Generally, the pest-deterrent barriers are configured to attach to a structure and to prevent pests from traversing the structure or from traversing an area in proximity to the structure. For example, FIG. 1 illustrates an embodiment wherein the pest-deterring barrier is a door sweep. In that embodiment, the pest-deterring barrier 100 is attached to a structure 101, i.e., the structure being a door. The door sweep embodiment deters pests from entering an enclosure through the space between the door and the ground. In other words, the door sweep 100 deters pests from traversing the area beneath the door, which is in proximity to the door 101. Many other embodiments of pest-deterrent barriers configured to attach to a variety of structures are described in more detail below.

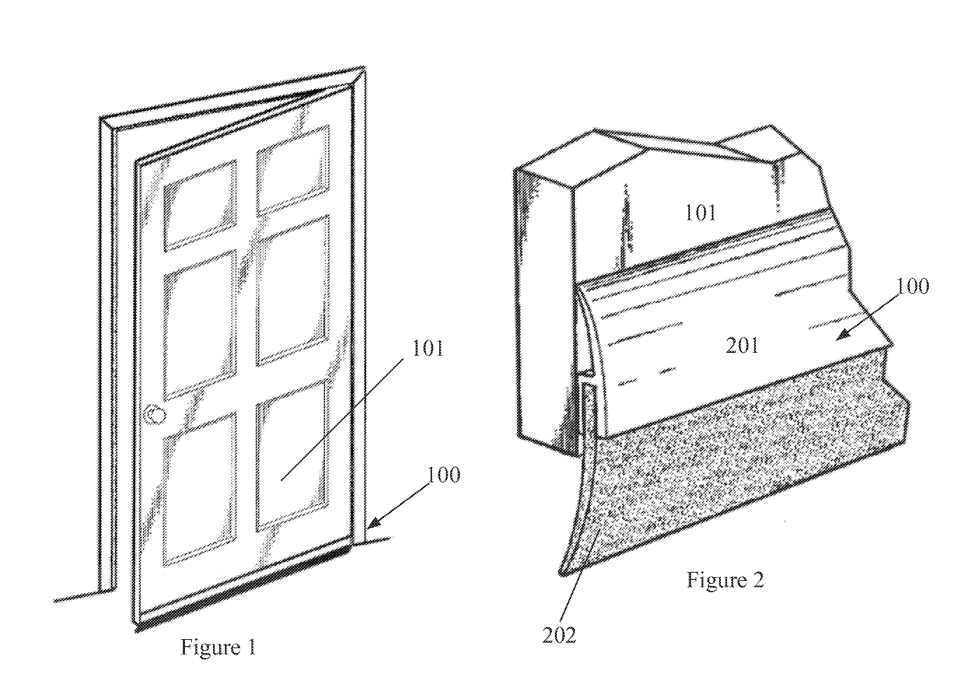

FIG. 2 illustrates a more close-up view of the door sweep embodiment of a pest-deterrent barrier 100. The pest-deterrent barrier features an attachment portion 201 and a barrier portion 202. The attachment portion 201 is configured to attach to the door 101. The attachment portion 201 is typically made of a rigid material, such as polyvinyl chloride (PVC) or another rigid plastic, wood, metal, etc. The attachment portion 201 may attach to the door using screws, tacks, adhesive, or the like, and generally attaches to the door permanently or semi-permanently (although it may attach to the door on a more temporary basis, as described further below).

Depending on the particular embodiment, the barrier portion 202 is typically a less rigid material, such as a flexible polymer material. One particular example of a suitable material is polyethylene such as a low density polyethylene (LDPE). Other polymer materials, such as polyvinylchloride (PVC) and the like may be used for the barrier portion.

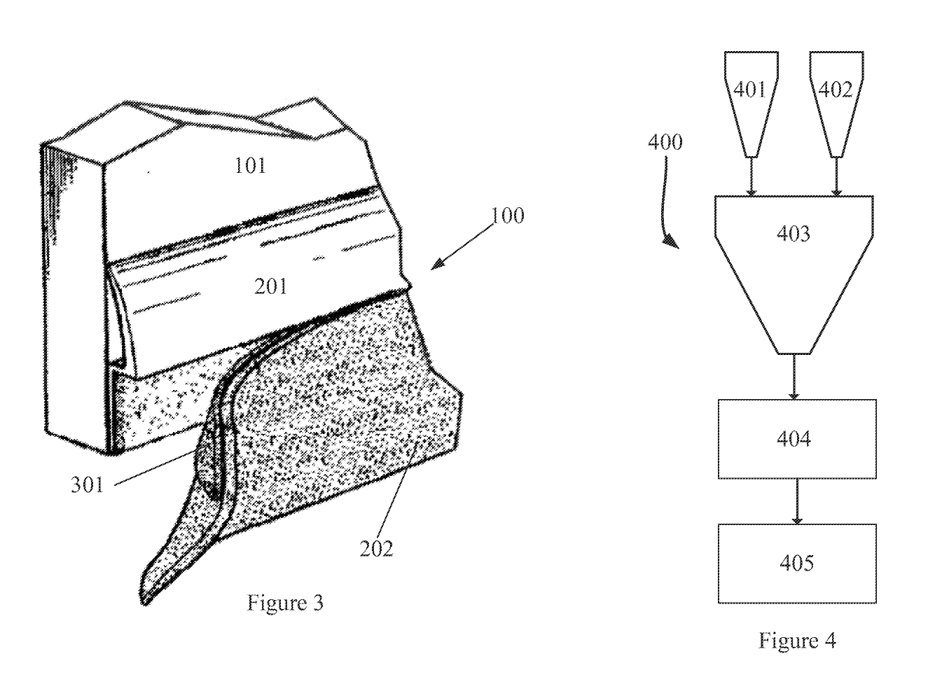

According to certain embodiments, the barrier portion 202 is attached to the attaching portion 201 in a more temporary fashion, so that the barrier portion 202 can be exchanged periodically. FIG. 3 illustrates an embodiment wherein the attaching portion 201 is attached to the structure 101 in a semi-permanent manner and barrier portion 202 is attached to the attaching portion 201 in a more temporary manner, namely by using an adhesive strip 301. The barrier portion may attach to the attachment portion in other ways, for example, using a tongue and groove arrangement (described below) or a hook and eye material (i.e., Velcro). Note that this discussion does not preclude embodiments wherein the attaching portion and the barrier portion are not separate components, but or instead provided by a single component that attaches directly to a structure, either temporarily, permanently, or semi-permanently.

The barrier portion 202 is impregnated with a compound or compounds that deter pests. As used herein, “deterring” pests can mean either repelling them or killing them. For example, the barrier portion 202 may be impregnated with a compound that repels pests so that they are not inclined to approach or traverse the barrier portion. Accordingly, the barrier portion 201 provides both a physical barrier and a chemical barrier. Examples of compounds that repel pests include chemical repellants such as N,N-Diethyl-3-methylbenzamide (DEET) or Ethyl butylacetylaminopropionate (IR3535). Particularly useful repellants are natural products, particularly EPA 25b Exempt Active ingredients (referred to herein as Exempt Active Ingredients). Examples of Exempt Active Ingredients are described in 40 U.S.C. §152.25(f). One useful class of compounds is terpene compounds. Particularly useful Exempt Active Ingredients include citronella and citronella oil, cedar oil, eugenol, geraniol, lemongrass oil mint and mint oil, peppermint and peppermint oil, thyme and thyme oil, and zinc metal strips.

As mentioned above, deterring pests can also mean killing them. In other words, the pest deterring compound can be one or more pesticides. Examples of useful pesticides include chemical pesticides, such as pyrethroids and neonicotinoids as well as abrasively active insecticides, such as diatomaceous earth and boric acid (which compromise an insect's exoskeleton as the insect contacts the barrier portion 202). In addition to the one or more pest-deterring compound(s), the barrier portion 202 may also include one or more antimicrobial compounds. Examples of suitable antimicrobial compounds include silver, zinc, and/or copper (in elemental or compound form). Elemental flakes, powder, microparticles, and/or nanoparticles of those metals are particularly useful antimicrobial compounds.

As mentioned above with respect to certain embodiments, the attachment portion is typically attached permanently or semi-permanently to the structure and the barrier portion is typically attached to the attaching portion in a more temporary manner. That arrangement facilitates replacing the barrier portion as the pest deterring compound(s) loses efficacy. Referring again to the door-sweep embodiment of FIGS. 1-3, if door-sweep 100 is a single unit, then the entire door sweep must be replaced when the impregnated barrier loses its efficacy over time. But in the embodiment wherein attachment portion 201 is attached permanently or semi-permanently to the structure 101 and the barrier portion 202 is attached to the attaching portion 201 in a more temporary manner, it is easy to replace the barrier portion when it loses efficacy. However, according to other embodiments, the attaching portion and the barrier portion are not separate components, but or instead provided by a single component that attaches directly to a structure, either temporarily, permanently, or semi-permanently.

The barrier portion 202 of the pest-deterring barrier 100 is made of a material that is impregnated with one or more pest-deterring compounds. The barrier material is typically a flexible polymer material such as LDPE. FIG. 4 illustrates a process 400 for making a polymer material impregnated with a pest-deterring compound. According to process 400, the pest-deterring material 401 and polymer resin 402 are mixed together to form composition 403. According to certain embodiments, the pest-deterring compound may be about 0.01% to about 40% by weight and the polymer may be about 50% to about 90%, based on the total weight of the mixture. According to some embodiments, more than one pest-deterring compound is used, for example, about 0.1% to about 15% of a first pest deterring compound, about 0.1% to about 15% of a second pest deterring compound, and about 0.1% to about 15% of a third pest deterring compound.

According to some embodiments, one or more materials in addition to the pest-deterring material 401 and polymer resin 402 may be mixed within composition 403. Example additional materials include carrier materials, sequestering agents, and the like. A particularly useful additional material is a molecular sieve material, which includes one or both of silicon oxide and/or aluminum oxide powder. The molecular sieve material is a zeolite material, and typically has on the order of 24-25 Å unit cell and a 7-8 Å pore size. The molecular sieve material may be mixed in the composition 403 at a concentration of about 5% to about 30%. According to some embodiments, the molecular sieve material may be first mixed with one or more of the pest-deterring compounds and then the combination added to the composition 403. A particularly useful composition contains about 5% to about 15% of a first pest-deterring compound, about 5% to about 10% of a second pest-deterring compound, about 1% to about 5% of a third pest-deterring compound, about 0.1% to about 2% of a fourth pest-deterring compound, about 10% to about 20% of a molecular sieve material, and about 50% to about 80% of LDPE. According to a certain embodiment, the first pest-deterring compound is geraniol, the second pest-deterring compound is mint oil, the third pest-deterring compound is cedar oil, and the fourth pest-deterring compound is eugenol. The barrier portion 202 material may include even further additional materials, such as flame retardants, UV protectants, and the like.

Referring again to FIG. 4, composition 403 is heated 404 to melt together the polymer resin 402 and the additional materials 401. It is within the ability of a person of skill in the art to determine the heating conditions (e.g., temperature and time) depending on the specific resins and other components. Generally, the heating temperature may be about 220° F. to about 300° F.

The melted composition 404 is then extruded to form an extruded composition 405. The extruded composition may be in the form of a wire, rope, cable, cylinder, block, or the like. The extruded composition 405 may be further processed by chipping or grinding to make chips or powder, respectively. Ultimately, the extruded composition 405 (with or without further processing) is used to make the barrier portion 202, typically using a molding process 406. Generally, any molding process suitable for the particular polymer base material can be used to make the barrier portion 202.

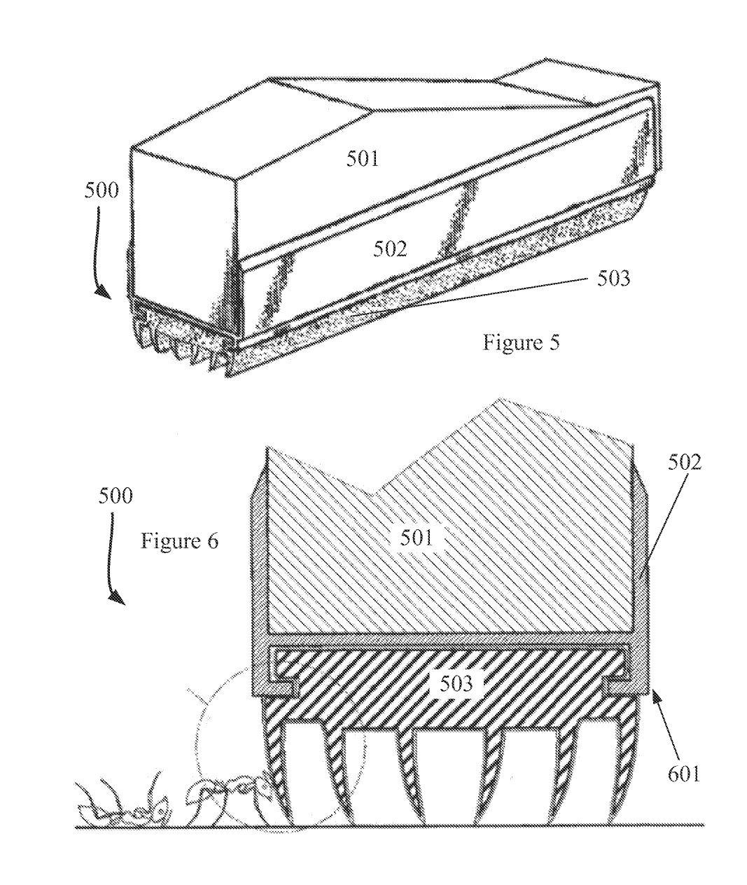

The concept of a pest-deterring barrier, as described herein, has been explained with reference to the door sweep embodiment illustrated in FIGS. 1-3. It should be appreciated, however, that many different embodiments are within the ability a person of skill in the art in light of this disclosure. For example, FIG. 5 illustrates an alternative embodiment of a pest-deterring barrier 500 attached to a structure 501, in this case a door such as a metal door. The attachment portion 502 fit over the end of the door and provides an attachment point for barrier portion 503. FIG. 6 illustrates a different view of pest-deterring barrier 500. The attachment portion 502 and the barrier portion 503 join in a tongue and groove mating arrangement 601.

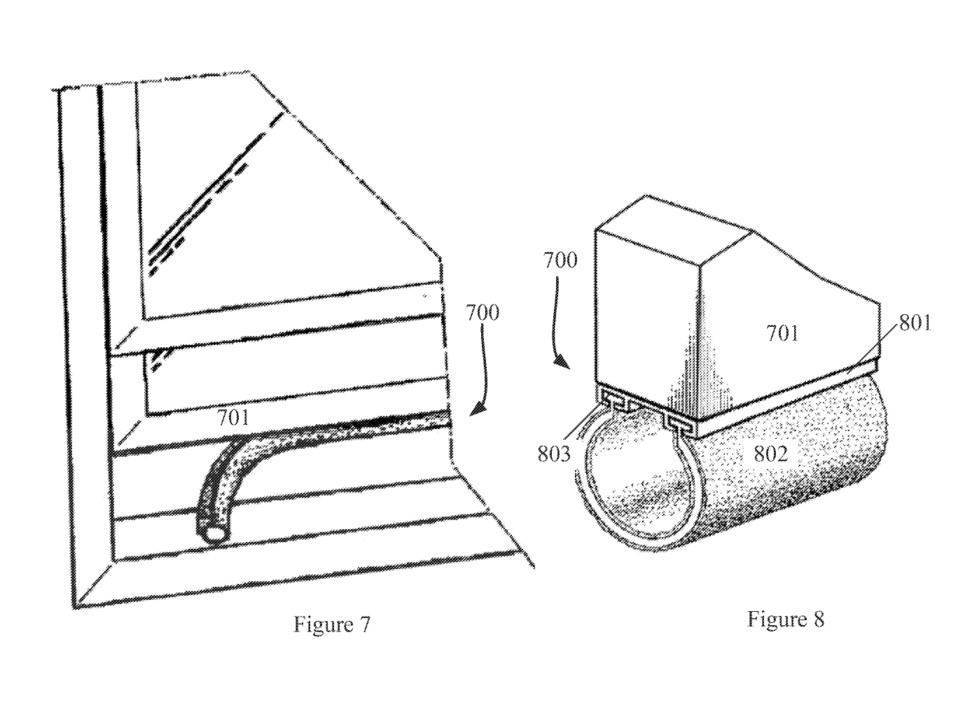

FIGS. 7 and 8 illustrate an embodiment of a pest-deterring barrier 700 configured to fit to the bottom edge of a window 701. The attachment portion 801 of the pest-deterring barrier 700 is configured to attach to the bottom of window 701, for example, by an adhesive or by a latching mechanism (not shown). The barrier portion 802 attaches to the attachment portion 801 as shown. In the embodiment illustrated in FIGS. 7 and 8, the barrier portion 802 may be exchangeable by simply removing it from grooves 803 of the attachment portion 801. Alternatively, the entire pest-deterring barrier 700 may be exchangeable.

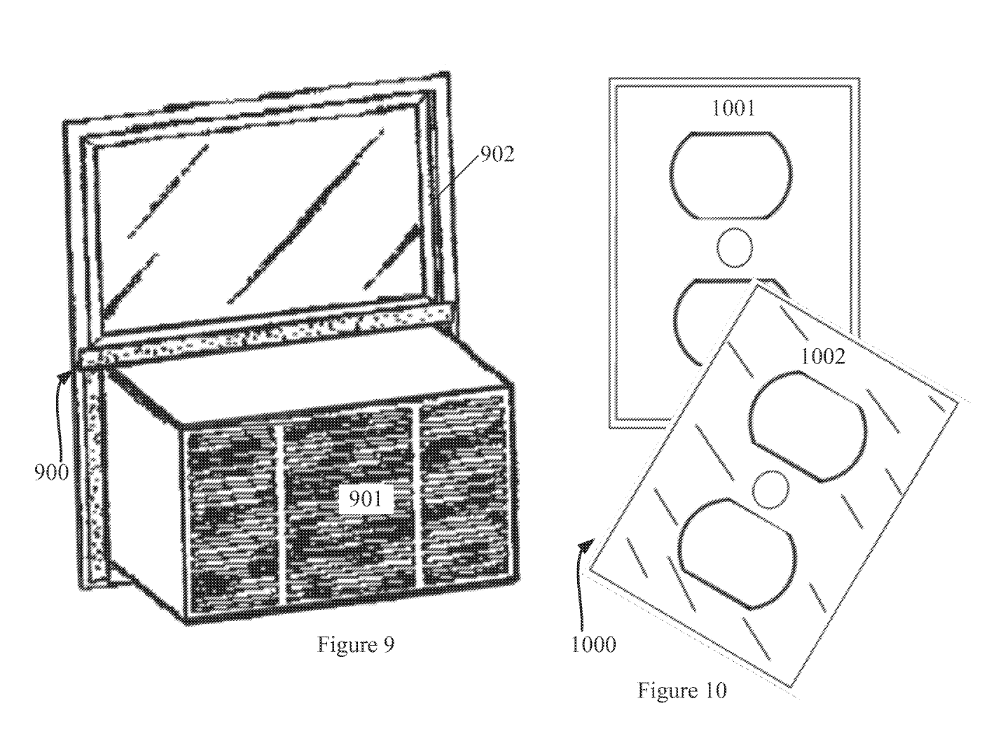

FIG. 9 illustrates an embodiment of a pest-deterring barrier 900 configured as a component of a housing for securing a window air conditioner unit 901 to a window 902. FIG. 10 illustrates an embodiment of a pest-deterring barrier 1000 configured as an insert for an electrical outlet cover 1001. Pest-deterring barrier 1000 can be configured such that the barrier portion 1002 attached directly to an existing electrical outlet cover 1001. In such a case, the barrier portion and the attachment portion are considered as a single unit. Alternatively, the barrier portion 1002 may be disposed upon a separate attachment portion (not shown), which attaches to the electrical outlet cover 1001.

A person of skill in the art will recognize and appreciate that many other embodiments of a pest-deterring barrier are possible based on the embodiments illustrated above. While the embodiments illustrated above relate primarily on preventing pests from entering a building or closet through doors, windows, or electrical fixtures, similar pest-deterring barriers can be configured to deter pests from entering other enclosures, such as vending machines, shipping containers, storage containers, such as barrels, breaker boxes, vehicles, and the like. The pest-deterrent barrier can be incorporated into flashing or fittings for all manner of openings in a structure, including ducting, plumbing openings through roofs, walls, and/or ceilings, electrical conduits, insulation, vents, and the like. The attachment portion can be configured to attach to structures such as a door, a window, a wall, an electrical receptacle or receptacle cover, a light switch or light switch cover, a container, an overhead door, a wiring harness or a pipe.

### EXAMPLES

### Example 1

### Insect Repellency

LDPE-based pest-deterrent barriers were prepared having the following composition: LDPE (74.6%), molecular sieve (10.0%), geraniol (7.5%), mint oil (5.0%), cedar oil (2.6%), and eugenol (0.3%). The barrier portion of the barriers had dimensions of 91 cm long, 2.54 cm high, and 0.32 cm in thickness. LDPE control barriers having the same dimensions but having no active ingredients were also prepared. The pest-deterrent barriers were aged for four months under ambient conditions to test efficacy.

Insect test arenas were constructed with dimensions of 50 cm in length, 40 cm in width, and 5 cm in height. The arena bottoms were covered with a white polyurethane sheet. Cut strips of the pest-deterrent barrier material and the control barrier material were placed so as to divide the chamber into thirds in the length dimension. Glue boards were mounted at both top and bottom center walls so that insects only had the options to stay in the middle or to move towards, away from, under or over the active pet-deterrent or control barriers. Active strips were placed into one arena and control strips were placed into a second arena. Both arenas were kept 1 meter from each other on a laboratory table. After each experiment the arena positions were exchanged and were also rotated 90 degrees clock wise to avoid any biases by location and lighting. The insects were gently inserted into the arenas by first placing them into a shallow box covered with a paperboard sheet. The shallow box was then placed into the center of the arena upside down and the cover removed. The upside down box was then removed after five minutes permitting the insects time to de-stress. The insects could then move freely about the arena for 5 minutes. Insects were permitted to cross over or under the two seals only one time and were then removed from the arena.

Two series of experiments were conducted. One series with the control and active strips lying flat on the arena floor (for bed bugs the strips were recessed into the polyurethane bottom to avoid acting as a physical barrier). The second set of experiments was conducted with the Test strips in a vertical position with a gap at the bottom. The gap was adjusted to be of sufficient height to just enable the tested insects to crawl under the seal.

The following insect species were tested: Bed Bugs, Black Crickets, American Cockroaches, German Cockroaches, Pharaoh Ants, Carpenter Ants, and Meal Beetles. Experiments for each insect species were run with cohorts of 10 insects with 10 repetitions in each of the active strip arenas and in the control strip arenas (200 insects in total). Each insect species experiment was conducted with fresh insects. Repellency rates were calculated with the number of insects crossing the active seal strips in one arena compared to the number of insects crossing the control strips in the second arena. Insects remaining in the center were not counted.

Repellency rates for insects exposed to active seals flat on the ground varied from 77.27% to 94.79% while vertical seals with adjusted gaps for the tested insects showed repellency rates from 83.54% to 93.67%. The results for each of tested insects are highly significant, as shown in Table 1.

TABLE 1
Calculated repellency rates (%).

| Insect | Flat Strip | Vertical Strip with Gap |
|---|---|---|
| Bed Bugs | 96.05 | 89.39 |
| Black Crickets | 87.06 | 86.11 |
| American Roaches | 80.49 | 83.54 |
| German Roaches | 84.34 | 88.31 |
| Carpenter Ants | 88.76 | 86.00 |
| Pharaoh Ants | 90.11 | 93.67 |
| Meal Beetles | 77.27 | 84.38 |

It is noteworthy that crickets and roaches were frequently probed the strips with their antenna before crossing. If exposed to active strips, they often moved parallel to the strips while repeatedly probing with their antenna. The few specimens that crossed flat active strips did this in a hesitating way and often with visible extended legs. A similar way of behavior and hesitation was observed with insects crawling under the vertical active strips (without visible extension of legs).

### Example 2

### Rodent Repellency

Active pest-deterrent strips and control strips were prepared as in Example 1. Mouse cages (6.5 cm×40 cm), mouse shelters (12 cm×12 cm), rat cages (100 cm×50 cm) and rat shelters (16 cm×16 cm) were purchased at a local pet shop. The cage floors were covered with wood shavings. An active strip (6.5 cm) was attached to the rear wall of one mouse shelter and a control strip (6.5 cm) was attached to the rear wall of the second mouse shelter. An active strip (10 cm) was attached to the rear wall of one rat shelter and a control strip (10 cm) was attached to the rear wall of the second rat shelter. Cotton was placed inside the shelters. The shelters were place in opposite corners of the cages. Six different house mice and six different rats were exposed one by one to the corresponding cages and observed until they entered one of the shelters. In total, each rodent was exposed 4 times to the experiment resulting in 24 repetitions each for mice and rats. The rodents were placed in the middle of the cages and given a choice which shelter to choose. After a rodent fully entered one of the shelters it was removed after one minute. After each rodent exposure the shelters were replaced (to avoid attraction by animal scent).

During the twenty four mouse trials, the mice entered the shelter with the control strip twenty times and only entered the shelter with the active strip four times. During the twenty four rat trials, the rats entered the shelter with the control strip twenty one times and only entered the shelter with the active strip three times. It is worthwhile mentioning that when rodents were examining the shelter with the active strip they often would only stick their head into the shelter and then, most of the time, would immediately retreat. When examining the Control strip shelter the rodents entered with their full body, often without hesitation. We additionally observed that rodents that entered the control strip shelter remained in the shelter, whereas the rodents that entered the active strip shelter stayed only for a few seconds.

### Example 3

### Deterring Rodent Gnawing

Peanut butter was inserted, using a syringe, into 16 cm lengths of tubing made from the active pest-deterring polymer material described in Experiment 1 (“active tubing”) and into similar lengths of inactive control tubing. Peanut butter was filled into the tubes to provide 10 cm lengths of peanut butter in the center of the tubes with empty 3 cm ends on each side. The same cohorts of mice and rats (six each) used in Experiment 2 were exposed to the tubes. The rodents could only reach the peanut butter by gnawing through the tubing. In one set of trials, single rodents were exposed to a pair of tubes (1 active and 1 controlled) over night for 12 hours. In every trial in that set of trials (24 rat trials and 24 mouse trials) the rodent gnawed through the control tube to get at the peanut butter and did not touch the active tube.

In a second set of trials (24 rat trials and 24 mouse trials), the rodents were exposed overnight only to an active tube. In two of the rat trials and five of the mouse trials the rodents were observed superficially gnawing on the active tube. In not case did the rodent gnaw on the tube enough to get to the peanut butter.

The foregoing disclosure and the showings made of the drawings are merely illustrative of the principles of this invention and are not to be interpreted in a limiting sense.

What is claimed is:

1. A pest-deterring barrier, comprising:
an attachment portion configured to attach to a structure; and
a barrier portion configured to deter pests from traversing the barrier portion or an area in proximity to the barrier portion; wherein
the barrier portion comprises a polymer material impregnated with one or more pest-deterring compounds.

2. The pest-deterring barrier of claim 1, wherein the structure is a door, a window, a wall, an electrical receptacle or receptacle cover, a light switch or light switch cover, a container, an overhead door, a wiring harness or a pipe.

3. The pest-deterring barrier of claim 1, wherein the barrier portion is configured to replaceably attach to the attachment portion.

4. The pest-deterring barrier of claim 1, wherein the barrier portion attaches to the attachment portion using an adhesive.

5. The pest-deterring barrier of claim 1, wherein the barrier portion attaches to the attachment portion in a tongue and groove arrangement.

6. The pest-deterring barrier of claim 1, wherein the barrier portion attaches to the attachment portion using a hook and loop fastener material.

7. The pest-deterring barrier of claim 1, wherein the barrier portion comprises a polyethylene material.

8. The pest-deterring barrier of claim 1, wherein the barrier portion comprises low density polyethylene.

9. The pest-deterring barrier of claim 1, wherein the pest-deterring compound is EPA 25b exempt.

10. The pest-deterring barrier of claim 1, wherein the pest-deterring compound is one or more compounds selected from the group consisting of citronella, citronella oil, cedar oil, eugenol, geraniol, lemongrass oil, mint, mint oil, peppermint, peppermint oil, thyme, thyme oil, and zinc metal strips.

11. The pest-deterring barrier of claim 1, wherein the barrier portion comprises a molecular sieve material.

12. The pest-deterring barrier of claim 1, wherein the barrier portion comprises an antimicrobial compound.

13. A replacement barrier portion for a pest-deterring barrier, the replacement barrier portion comprising:
a polymer material impregnated with one or more pest-deterring compounds, wherein
the replacement barrier portion is configured to attach to an attaching portion of the pest-deterring barrier, and when so configured, to deter pests from traversing the barrier portion or an area in proximity to the barrier portion, and wherein
the attachment portion is configured to attach to a structure.

14. The replacement barrier portion of claim 13, wherein the barrier portion attaches to the attachment portion using an adhesive, in a tongue and groove arrangement, or using a hook and eye material.

15. The replacement barrier portion of claim 13, wherein the pest-deterring compound is EPA 25b exempt.

16. The replacement barrier portion of claim 13, wherein the pest-deterring compound is one or more compounds selected from the group consisting of citronella, citronella oil, cedar oil, eugenol, geraniol, lemongrass oil, mint, mint oil, peppermint, peppermint oil, thyme, thyme oil, and zinc metal strips.

17. A method of deterring pests, the method comprising:
attaching a pest-deterring barrier to a structure, wherein the pest-deterring barrier comprises:
an attachment portion configured to attach to the structure; and
a barrier portion configured to deter pests from traversing the barrier portion or an area in proximity to the barrier portion; wherein
the barrier portion comprising a polymer material impregnated with one or more pest-deterring compounds.

18. The method of claim 17, wherein the structure a door, a window, a wall, an electrical receptacle or receptacle cover, a light switch or light switch cover, a container, an overhead door, a wiring harness or a pipe.

19. The method of claim 17, wherein the barrier portion is configured to attach to the attachment portion using an adhesive, in a tongue and groove arrangement, or using a hook and eye material.

20. The method of claim 17, further comprising exchanging the barrier portion with a fresh barrier portion.
